(19) United States
(12) Patent Application Publication
(10) Pub. No.: US 2023/0134385 A1
(43) Pub. Date: May 4, 2023

(54) APPARATUS, SYSTEM, AND METHOD OF A TRANSMISSION CONFIGURED FOR CHANNEL-SOUNDING-BASED MEASUREMENT

(71) Applicant: INTEL CORPORATION, SANTA CLARA, CA (US)

(72) Inventors: Qinghua Li, San Ramon, CA (US); Hao Song, Santa Clara, CA (US); Cheng Chen, Camas, WA (US); Xiaogang Chen, Portland, OR (US); Juan Fang, Portland, OR (US); Jonathan Segev, Sunnyvale, CA (US)

(73) Assignee: INTEL CORPORATION, SANTA CLARA, CA (US)

(21) Appl. No.: 18/091,031

(22) Filed: Dec. 29, 2022

Related U.S. Application Data
(60) Provisional application No. 63/350,536, filed on Jun. 9, 2022.

(51) Int. Cl. H04L 27/26

(52) U.S. Cl. CPC H04L 27/2613; H04L 27/2605

(57) ABSTRACT

For example, a wireless communication device may be configured to disable a per-antenna Cyclic Shift Diversity (CSD) insertion for a Long Training Field (LTF) of a Physical Layer (PHY) Protocol Data Unit (PPDU), for example, based on a determination that the PPDU is to be configured for a predefined type of channel-sounding-based measurement. For example, the per-antenna CSD insertion may include insertion of a CSD between a plurality of transmit chains of the wireless communication device. For example, the wireless communication device may be configured to transmit the LTF of the PPDU via the plurality of transmit chains with the per-antenna CSD insertion disabled.

### CROSS REFERENCE

This Application claims the benefit of and priority from U.S. Provisional Pat. Application No. 63/350,536 entitled “CYCLIC SHIFT DIVERSITY CONFIGURATION FOR SENSING”, filed Jun. 9, 2022, the entire disclosure of which is incorporated herein by reference.

### TECHNICAL FIELD

Aspects described herein generally relate to transmissions configured for channel-sounding-based measurement.

### BACKGROUND

Some wireless communication devices may be configured to support ranging and/or sensing techniques over a wireless communication channel, e.g., according to an IEEE 802.11 Specification.

For example, the ranging and/or sensing techniques may be implemented to determine ranging and/or sensing information, for example, based on channel-sounding-based measurements, which may be performed on wireless transmissions.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a Physical layer (PHY) Protocol Data Unit (PPDU) format, in accordance with some demonstrative aspects.

FIG. 3 is a schematic illustration of a transmission scheme of a transmitter, in accordance with some demonstrative aspects.

FIG. 4 is a schematic illustration of a transmission of a spatial stream between multiple antennas of a transmitter and an antenna of a receiver, to demonstrate a technical problem, which may be addressed in accordance with some demonstrative aspects.

FIG. 5 is a schematic illustration of a PPDU format, which may be implemented in accordance with some demonstrative aspects.

FIG. 6 is a schematic illustration of a PPDU format, which may be implemented in accordance with some demonstrative aspects.

FIG. 7 is a schematic flow-chart illustration of a method of transmitting a PPDU configured for a channel-sounding-based measurement, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer’s registers and/or memories into other data similarly represented as physical quantities within the computer’s registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology— Telecommunications and Information Exchange between Systems Local and Metropolitan Area Networks—Specific Requirements; Part 11 Wireless LAN Medium Access Control (MAC) and Physical Layer (PHY) Specifications, December, 2020); IEEE 802.11ax (IEEE P802.11ax-2021, IEEE Standard for Information Technology— Telecommunications and Information Exchange between Systems Local and Metropolitan Area Networks—Specific Requirements; Part 11: Wireless LAN Medium Access Control (MAC) and Physical Layer (PHY) Specifications; Amendment 1: Enhancements for High-Efficiency WLAN, February, 2021); IEEE 802.11az (P802.11az™/D6.0; Draft Standard for Information technology— Telecommunications and information exchange between systems Local and metropolitan area networks— Specific requirements; Part 11: Wireless LAN Medium Access Control 11 (MAC) and Physical Layer (PHY) Specifications; Amendment 4: Enhancements for positioning, August 2022); IEEE 802.11bf (; IEEE P802.11bf™/D0.4Draft Standard for Information technology— Tele-communications and information exchange between systems Local and metropolitan area networks—Specific requirements; Part 11: Wireless LAN Medium Access Control (MAC) and Physical Layer (PHY) Specifications; Amendment 2: Enhancements for Wireless LAN Sensing, November 2022); and/or IEEE 802.11be (IEEE P802.11be/D2.0 Draft Standard for Information technology— Telecommunications and information exchange between systems Local and metropolitan area networks— Specific requirements; Part 11: Wireless LAN Medium Access Control (MAC)and Physical Layer (PHY)Specifications; Amendment 8: Enhancements for extremely high throughput (EHT), May 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multistandard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

Some demonstrative aspects may be implemented by an Extremely High Throughput (EHT) STA, which may include for example, a STA having a radio transmitter, which is capable of operating on a channel that is in frequency bands between 1 GHz and 7.250 GHz. The EHT STA may perform other additional or alternative functionality. Other aspects may be implemented by any other apparatus, device and/or station.

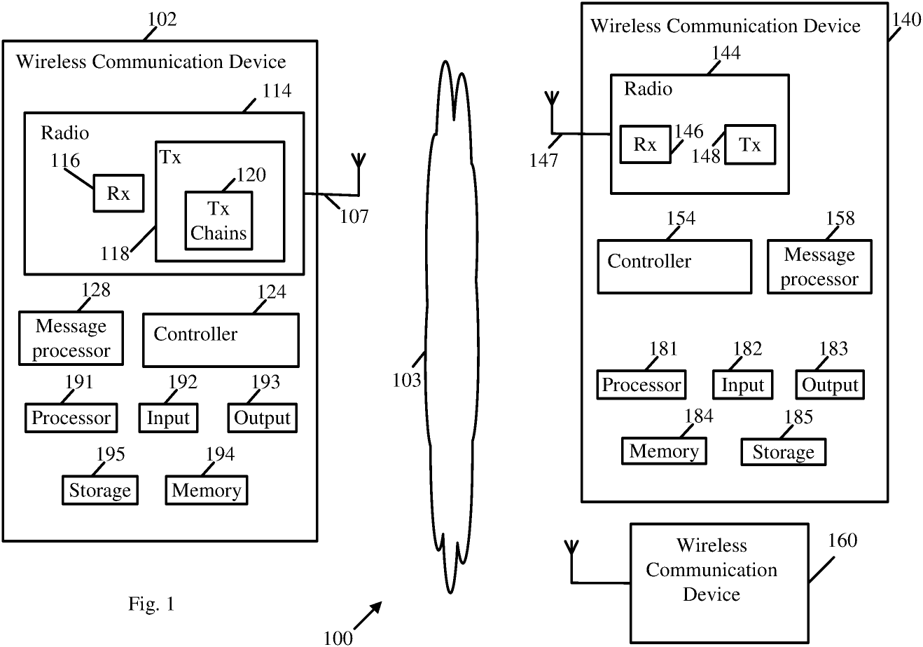

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a Smartphone, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a video source, an audio source, a video sink, an audio sink, a stereo tuner, a broadcast radio receiver, a digital audio player, a speaker, an audio receiver, an audio amplifier, a gaming device, a data source, a data sink, a media player, a television, a music player, a smart device such as, for example, lamps, climate control, car components, household components, appliances, and the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an OS of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, a cellular channel, an RF channel, a Wi- Fi channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10Ghz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in a mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include at least one radio 114, and/or device 140 may include at least one radio 144.

In some demonstrative aspects, radio 114 and/or radio 144 may include one or more wireless receivers (Rx) including circuitry and/or logic to receive wireless communication signals, RF signals, frames, blocks, transmission streams, packets, messages, data items, and/or data. For example, radio 114 may include at least one receiver 116, and/or radio 144 may include at least one receiver 146.

In some demonstrative aspects, radio 114 and/or radio 144 may include one or more wireless transmitters (Tx) including circuitry and/or logic to transmit wireless communication signals, RF signals, frames, blocks, transmission streams, packets, messages, data items, and/or data. For example, radio 114 may include at least one transmitter 118, and/or radio 144 may include at least one transmitter 148.

In some demonstrative aspects, radio 114 and/or radio 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radio 114 and/or radio 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, a mmWave band, and/or any other band, for example, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more, e.g., a single antenna or a plurality of, antennas 107, and/or device 140 may include on or more, e.g., a plurality of, antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. Antennas 107 and/or 147 may include, for example, antennas suitable for directional communication, e.g., using beamforming techniques. For example, antennas 107 and/or 147 may include a single antenna, a plurality of antennas, a phased array antenna, a multiple element antenna, a set of switched beam antennas, and/or the like. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, antennas 107 and/or antennas 147 may be connected to, and/or associated with, one or more Radio Frequency (RF) chains.

In some demonstrative aspects, transmitter 118 may include a plurality of Tx chains 120 configured to generate and transmit the Tx RF signals via a plurality of Tx antennas 107, e.g., respectively.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of radio 114. For example, the chip or SoC may include one or more elements of controller 124, one or more elements of message processor 128, and/or one or more elements of radio 114. In one example, controller 124, message processor 128, and radio 114 may be implemented as part of the chip or SoC.

In other aspects, controller 124, message processor 128 and/or radio 114 may be implemented by one or more additional or alternative elements of device 102.

In some demonstrative aspects, at least part of the functionality of controller 154 and/or message processor 158 may be implemented by an integrated circuit, for example, a chip, e.g., a System on Chip (SoC). In one example, the chip or SoC may be configured to perform one or more functionalities of radio 144. For example, the chip or SoC may include one or more elements of controller 154, one or more elements of message processor 158, and/or one or more elements of radio 144. In one example, controller 154, message processor 158, and radio 144 may be implemented as part of the chip or SoC.

In other aspects, controller 154, message processor 158 and/or radio 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more EHT STAs. For example, device 102 may include, operate as, perform the role of, and/or perform one or more functionalities of, at least one EHT STA; device 140 may include, operate as, perform the role of, and/or perform one or more functionalities of, at least one EHT STA; and/or device 160 may include, operate as, perform the role of, and/or perform one or more functionalities of, at least one EHT STA.

In other aspects, devices 102, 140, and/or 160 may include, operate as, perform the role of, and/or perform one or more functionalities of, any other wireless device and/or station, e.g., a WLAN STA, a Wi- Fi STA, and the like.

In some demonstrative aspects, device 102, device 140, and/or device 160 may be configured operate as, perform the role of, and/or perform one or more functionalities of, an access point (AP), e.g., an EHT AP, or any other AP.

In some demonstrative aspects, device 102, device 140, and/or device 160 may be configured to operate as, perform the role of, and/or perform one or more functionalities of, a non-AP STA, e.g., an EHT non-AP STA, or any other non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains a station (STA), e.g., one STA, and provides access to distribution services, via the wireless medium (WM) for associated STAs. The AP may perform any other additional or alternative functionality.

In one example, a non-AP STA may include a STA that is not contained within an AP. The non-AP STA may perform any other additional or alternative functionality.

In some demonstrative aspects devices 102, 140, and/or 160 may be configured to communicate over an EHT network, and/or any other network. For example, devices 102, 140, and/or 160 may perform Multiple-Input-Multiple-Output (MIMO) communication, for example, for communicating over the EHT networks, e.g., over an EHT frequency band, e.g., in frequency bands between 1 GHz and 7.250 GHz.

In some demonstrative aspects, devices 102, 140, and/or 160 may be configured to operate in accordance with one or more Specifications, for example, including one or more IEEE 802.11 Specifications, e.g., an IEEE 802.11-2020 Specification, an IEEE 802.11be Specification, an IEEE 802.11bf Specification, an IEEE 802.11az Specification, an IEEE 802.11ax Specification, and/or any other specification and/or protocol.

In some demonstrative aspects, devices 102, 140, and/or 160 may be configured according to one or more standards, for example, in accordance with an IEEE 802.11ax Standard, an IEEE 802.11az Standard, an IEEE 802.11bf Standard, and/or an IEEE 802.11be Standard, which may be configured, for example, to enhance the efficiency and/or performance of an IEEE 802.11 Specification, which may be configured to provide Wi-Fi connectivity.

Some demonstrative aspects may enable, for example, to significantly increase the data throughput defined in the IEEE 802.11-2020 Specification, for example, up to a throughput of 30 Giga bits per second (Gbps), or to any other throughput, which may, for example, satisfy growing demand in network capacity for new coming applications.

Some demonstrative aspects may be implemented, for example, to support increasing a transmission data rate, for example, by applying MIMO and/or Orthogonal Frequency Division Multiple Access (OFDMA) techniques.

In some demonstrative aspects, devices 102, 140, and/or 160 may be configured to communicate MIMO communications and/or OFDMA communication in frequency bands between 1 GHz and 7.250 GHz.

In some demonstrative aspects, device 102, device 140, and/or device 160 may be configured to support one or more mechanisms and/or features, for example, OFDMA, Single User (SU) MIMO, and/or Multi-User (MU) MIMO, for example, in accordance with an IEEE 802.11be Standard and/or any other standard and/or protocol.

In some demonstrative aspects, device 102, device 140, and/or device 160 may include, operate as, perform a role of, and/or perform the functionality of, one or more EHT STAs. For example, device 102 may include, operate as, perform a role of, and/or perform the functionality of, at least one EHT STA, device 140 may include, operate as, perform a role of, and/or perform the functionality of, at least one EHT STA, and/or device 160 may include, operate as, perform a role of, and/or perform the functionality of, at least one EHT STA.

In some demonstrative aspects, devices 102, 140, and/or 160 may implement a communication scheme, which may include Physical layer (PHY) and/or Media Access Control (MAC) layer schemes, for example, to support one or more applications, and/or increased throughput, e.g., throughputs up to 30 Gbps, or any other throughput.

In some demonstrative aspects, the PHY and/or MAC layer schemes may be configured to support OFDMA techniques, SU MIMO techniques, and/or MU MIMO techniques.

In some demonstrative aspects, devices 102, 140, and/or 160 may be configured to implement one or more mechanisms, which may be configured to enable SU and/or MU communication of Downlink (DL) and/or Uplink frames (UL) using a MIMO scheme.

In some demonstrative aspects, device 102, device 140, and/or device 160 may be configured to implement one or more MU communication mechanisms. For example, devices 102, 140, and/or 160 may be configured to implement one or more MU mechanisms, which may be configured to enable MU communication of DL frames using a MIMO scheme, for example, between a device, e.g., device 102, and a plurality of devices, e.g., including device 140, device 160, and/or one or more other devices.

In some demonstrative aspects, devices 102, 140, and/or 160 may be configured to communicate over an EHT network, and/or any other network and/or any other frequency band. For example, devices 102, 140, and/or 160 may be configured to communicate DL transmissions and/or UL transmissions, for example, for communicating over the EHT networks.

In some demonstrative aspects, devices 102, 140, and/or 160 may be configured to communicate over a channel bandwidth, e.g., of at least 20 Megahertz (MHz), in frequency bands between 1 GHz and 7.250 GHz.

In some demonstrative aspects, devices 102, 140, and/or 160 may be configured to implement one or more mechanisms, which may, for example, support communication over a wide channel bandwidth (BW) (“channel width”) (also referred to as a “wide channel” or “wide BW”) covering two or more channels, e.g., two or more 20 MHz channels, e.g., as described below.

In some demonstrative aspects, wide channel mechanisms may include, for example, a mechanism and/or an operation whereby two or more channels, e.g., 20 MHz channels, can be combined, aggregated or bonded, e.g., for a higher bandwidth of packet transmission, for example, to enable achieving higher throughputs, e.g., when compared to transmissions over a single channel. Some demonstrative aspects are described herein with respect to communication over a channel BW including two or more 20 MHz channels, however other aspects may be implemented with respect to communications over a channel bandwidth, e.g., a “wide” channel, including or formed by any other number of two or more channels, for example, a bonded or aggregated channel including a bonding or an aggregation of two or more channels.

In some demonstrative aspects, device 102, device 140, and/or device 160 may be configured to communicate one or more transmissions over one or more channel BWs, for example, including a channel BW of 20 MHz, a channel BW of 40 MHz, a channel BW of 80 MHz, a channel BW of 160 MHz, a channel BW of 320 MHz, and/or any other additional or alternative channel BW, e.g., as described below.

In some demonstrative aspects, device 102, device 140, and/or device 160 may be configured to support communications, for example, in accordance with an IEEE 802.11 Specification.

In some demonstrative aspects, device 102, device 140, and/or device 160 may be configured to communicate one or more Physical Layer (PHY) Protocol Data Units (PPDUs), for example, in accordance with an IEEE 802.11 Specification.

In some demonstrative aspects, device 102, device 140, and/or device 160 may be configured to generate, transmit, receive, and/or process one or more transmissions of PPDUs, e.g., as described below.

In some demonstrative aspects, controller 124 may be configured to control, trigger, cause, and/or instruct device 102 to transmit a PPDU, e.g., as described below.

In some demonstrative aspects, controller 154 may be configured to control, trigger, cause, and/or instruct device 140 to process the PPDU, e.g., as described below.

In some demonstrative aspects, the PPDU may include a Legacy preamble, e.g., as described below.

In some demonstrative aspects, the PPDU may include a Legacy Short Training Field (L-STF), e.g., as described below.

In some demonstrative aspects, the PPDU may include a Long Training Field (LTF), for example, a first LTF, e.g., a Legacy LTF (L-LTF). For example, the LTF may be after the L-STF, e.g., as described below.

In some demonstrative aspects, the PPDU may include a legacy Signal (L-SIG) field, for example, after the L-LTF, e.g., as described below.

In some demonstrative aspects, the PPDU may include a second LTF, for example, a Non-legacy LTF, e.g., as described below.

In some demonstrative aspects, the PPDU may include a Packet Extension (PE) field, e.g., as described below.

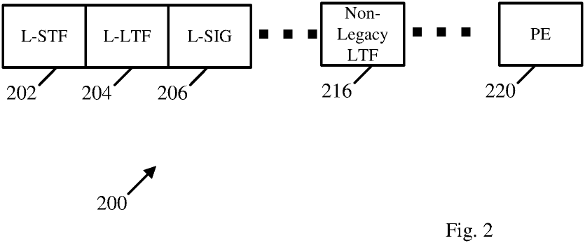

Reference is made to FIG. 2, which schematically illustrates a PPDU format 200, which may be implemented in accordance with some demonstrative aspects. In one example, devices 102 (FIG. 1), 140 (FIG. 1), and/or 160 (FIG. 1) may be configured to generate, transmit, receive, and/or process one or more PPDUs having the structure and/or format of PPDU 200.

In some demonstrative aspects, devices 102 (FIG. 1), 140 (FIG. 1), and/or 160 (FIG. 1) may communicate PPDU 200, for example, as part of a transmission between devices 102 (FIG. 1), 140 (FIG. 1), and/or 160 (FIG. 1), e.g., as described below.

In some demonstrative aspects, PPDU 200 may be configured, for example, in compliance with a format of an IEEE 802.11 Standard.

In some demonstrative aspects, as shown in FIG. 2, PPDU 200 may include an L-STF 202.

In some demonstrative aspects, the PPDU may include a Long Training Field (LTF) 204, for example, a first LTF, for example, a Legacy LTF (L-LTF). For example, the L-LTF 204 may be after the L-STF 202.

In some demonstrative aspects, as shown in FIG. 2, PPDU 200 may include an L-SIG field 206.

In some demonstrative aspects, as shown in FIG. 2, PPDU 200 may include a second LTF, for example, non-legacy LTF 216, e.g., as described below.

In some demonstrative aspects, as shown in FIG. 2, PPDU 200 may include, for example, a PE field 220.

Referring back to FIG. 1, in some demonstrative aspects, device 102, device 140, and/or device 160 may be configured to apply a per-antenna Cyclic Shift Diversity (CSD) insertion (also referred to as “per-chain CSD insertion”) for one or more fields of a transmitted PPDU, e.g., as described below.

In some demonstrative aspects, the per-antenna CSD insertion may include insertion of a CSD between a plurality of transmit chains of a transmitter of the PPDU. For example, transmitter 118 may be configured to insert a CSD between transmit chains 120, e.g., as described below.

In some demonstrative aspects, the per-antenna CSD insertion may be implemented, for example, to enhance reliability of communication of the PPDU, e.g., as described below.

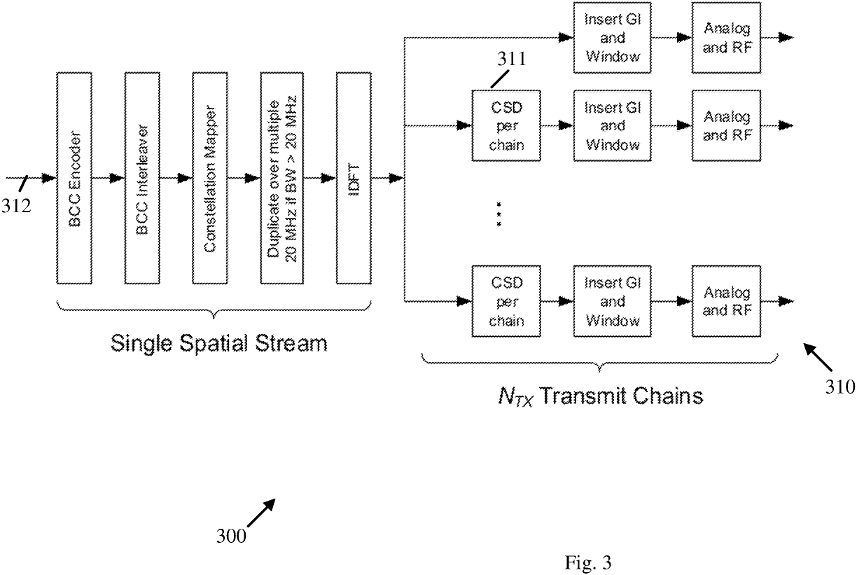

Reference is made to FIG. 3, which schematically illustrates a transmission scheme 300 of a transmitter, in accordance with some demonstrative aspects.

In some demonstrative aspects, transmission scheme 300 may be configured for transmission of a spatial stream 312, e.g., a single spatial stream 312, via a plurality of Tx chains 310.

In some demonstrative aspects, transmitter 118 (FIG. 1) may be configured to implement one or more elements and/or functionalities of transmission scheme 300, for example, to transmit one or more fields of a PPDU, e.g., one or more fields of PPDU 200 (FIG. 2), via the plurality of Tx chains 120 (FIG. 1).

In some demonstrative aspects, as shown in FIG. 3, transmission scheme 300 may be configured to apply per-antenna (per-chain) CSD insertion 311 to the spatial stream 312, for example, by insertion of a CSD between the plurality of Tx chains 310.

In some demonstrative aspects, as shown in FIG. 3, the per-antenna CSD insertion may be implemented by configuring the plurality of Tx chains 310 to send the same signals, e.g., of the spatial stream 312, with different cyclic delays. For example, for a single stream transmission, e.g., a single spatial stream 312, a same signal may be transmitted by multiple antennas with different CSD delays.

In some demonstrative aspects, the per-antenna CSD insertion (also referred to as “per-chain CSD insertion” or “per Tx chain CSD insertion”) may be applied, for example, according to a spatial mapping matrix, for example, in accordance with an IEEE801.11 standard.

For example, per chain CSD values may be specified by a spatial mapping matrix, denoted Qₖ, for a subcarrier, denoted k, e.g., for each subcarrier k.

For example, the spatial mapping matrix may be implementation specific.

In one example, e.g., according to a direct mapping scheme, the mapping matrix Qₖ may include a diagonal matrix of unit magnitude complex values, which may take one of two forms, e.g., as follows:
1. Qₖ = I, the identity matrix;
2. A CSD matrix in which the diagonal elements represent cyclic shift in the time domain, e.g., as follows:
$${\left[{Q}_{k}\right]}_{i , i} = e x p \left(- j 2 π k {Δ}_{F} {τ}_{C S}^{i}\right)$$
wherein
$${τ}_{C S}^{i} , i = 1 , … , {N}_{T X}$$
represents the CSD applied.

In another example, e.g., according to an indirect mapping scheme, the mapping matrix Qₖ may be a product of a CSD matrix and a unitary matrix, e.g., a Hadamard matrix, a Fourier matrix, or any other matrix.

In another example, e.g., according to a spatial expansion scheme, the mapping matrix Qₖ may be a product of a CSD matrix and a square matrix formed of orthogonal columns, e.g., as follows:

The spatial expansion may be performed by duplicating some of N_{STS} space-time streams to form the N_{TX} streams, e.g., with each stream being scaled by a normalization factor, e.g.,

$$\sqrt{{\text{N}}_{\text{STS}} / {\text{N}}_{\text{TX}} .}$$

For example, the spatial expansion may be performed by using one or more matrices, denoted D, left multiplied by a CSD matrix, denoted M_{CSD}(k), and/or possibly multiplied by any unitary matrix. For example, a resulting spatial mapping matrix may be, e.g., as follows:

$${Q}_{k} = {M}_{C S D} \left(k\right) ⋅ D$$

wherein D may have, for example, one of the following values:

$${\text{N}}_{\text{TX}} \text{=} 2 , {\text{N}}_{\text{STS}} \text{=1, D =} \frac{1}{\sqrt{2}} {\left[\begin{matrix}1 & 1\end{matrix}\right]}^{\text{T}}$$

$${\text{N}}_{\text{TX}} \text{=3} , {\text{N}}_{\text{STS}} \text{=1, D =} \frac{1}{\sqrt{3}} {\left[\begin{matrix}1 & 1 & 1\end{matrix}\right]}^{\text{T}}$$

$${\text{N}}_{\text{TX}} \text{=4} , {\text{N}}_{\text{STS}} \text{=1, D =} \frac{1}{2} {\left[\begin{matrix}1 & 1 & 1 & 1\end{matrix}\right]}^{\text{T}}$$

$${\text{N}}_{\text{TX}} {\text{=3, NS}}_{\text{TS}} \text{=2, D =} \sqrt{\frac{2}{3}} \left[\begin{matrix}1 & 0 \\ 0 & 1 \\ 1 & 0\end{matrix}\right]$$

In some demonstrative aspects, device 102, device 140, and/or device 160 may be configured to support, perform, participate in, and/or communicate one or more transmissions of, one or more types of channel-sounding-based measurements, e.g., as described below.

In some demonstrative aspects, device 102, device 140, and/or device 160 may be configured to support, perform, participate in, and/or communicate one or more transmissions of, the channel-sounding-based measurements, for example, in accordance with an IEEE 802.11 Specification, e.g., as described below.

In some demonstrative aspects, device 102, device 140, and/or device 160 may be configured to support, perform, participate in, and/or communicate one or more transmissions of, the channel-sounding-based measurements, for example, in accordance with an IEEE 802.11bf Specification, e.g., as described below.

In some demonstrative aspects, device 102, device 140, and/or device 160 may be configured to support, perform, participate in, and/or communicate one or more transmissions of, channel-sounding-based sensing operations and/or communications, for example, in accordance with an IEEE 802.11bf Specification.

In some demonstrative aspects, device 102, device 140, and/or device 160 may be configured to support, perform, participate in, and/or communicate one or more transmissions of, wireless sensing channel-sounding-based measurements, for example, in accordance with an IEEE 802.11bf Specification, e.g., as described below.

In some demonstrative aspects, device 102, device 140, and/or device 160 may be configured to implement sensing techniques to determine sensing information based on measurements performed according to the wireless sensing channel-sounding-based measurements, e.g., as described below.

In some demonstrative aspects, device 102, device 140, and/or device 160 may be configured to support, perform, participate in, and/or communicate one or more transmissions of, the channel-sounding-based measurements, for example, in accordance with an IEEE 802.11az Specification, e.g., as described below.

In some demonstrative aspects, device 102, device 140, and/or device 160 may be configured to support, perform, participate in, and/or communicate one or more transmissions of, ranging operations and/or communications, for example, in accordance with an IEEE 802.11az Specification.

In some demonstrative aspects, device 102, device 140, and/or device 160 may be configured to support, perform, participate in, and/or communicate one or more transmissions of, wireless ranging channel-sounding-based measurements, e.g., in accordance with an IEEE 802.11az Specification, e.g., as described below.

In some demonstrative aspects, device 102, device 140, and/or device 160 may be configured to implement ranging techniques to determine ranging information based on measurements performed according to the wireless ranging channel-sounding-based measurements, e.g., as described below.

In some demonstrative aspects, device 102, device 140, and/or device 160 may be configured to communicate transmissions configured for the channel-sounding-based measurement, e.g., as described below.

In some demonstrative aspects, device 102, device 140, and/or device 160 may be configured to communicate a PPDU, which may be configured for a channel-sounding-based measurement, for example, to provide a technical solution to support the channel-sounding-based measurements, e.g., as described below.

In some demonstrative aspects, device 102, device 140, and/or device 160 may be configured to communicate a PPDU, which may be configured for a wireless sensing channel-sounding-based measurement, for example, to provide a technical solution to support the wireless sensing, e.g., as described below.

In some demonstrative aspects, the PPDU may be configured based on, and/or in compliance with, a format of an Extremely High Throughput (EHT) PPDU, for example, in accordance with an IEEE 802.11be Specification and/or an IEEE 802.11bf Specification, e.g., as described below.

In some demonstrative aspects, device 102, device 140, and/or device 160 may be configured to communicate a PPDU configured for a wireless ranging channel-sounding-based measurement, for example, to provide a technical solution to support the wireless ranging, e.g., as described below.

In some demonstrative aspects, the PPDU may be configured based on, and/or in compliance with, a format of a High Efficiency (HE) PPDU, for example, in accordance with an IEEE 802.11ax Specification and/or an IEEE 802.11az Specification, e.g., as described below.

In some demonstrative aspects, device 102, device 140, and/or device 160 may be configured to perform the channel-sounding-based measurements, for example, based on an LTF of the PPDU. For example, device 102, device 140, and/or device 160 may be configured to perform the channel-sounding-based measurements, for example, based on non-legacy LTF 216 (FIG. 2).

In some demonstrative aspects, device 102, device 140, and/or device 160 may be configured to communicate the LTF of the PPDU, for example, as part of one or more channel-sounding-based measurements, e.g., as described below.

In some demonstrative aspects, controller 124 may be configured to control, trigger, cause, and/or instruct device 102 to generate an LTF, which may be configured for a channel-sounding-based measurement, e.g., as described below.

In some demonstrative aspects, controller 124 may be configured to control, trigger, cause, and/or instruct device 102 to transmit a PPDU including the LTF, e.g., as described below.

In some demonstrative aspects, controller 154 may be configured to control, trigger, cause, and/or instruct device 140 to process the PPDU including LTF, e.g., received from device 102.

In some demonstrative aspects, controller 154 may be configured to control, trigger, cause, and/or instruct device 140 to determine one or more wireless sensing channel-sounding-based measurements and/or wireless ranging channel-sounding-based measurements, for example, based on the LTF in the PPDU from device 102.

In some demonstrative aspects, for example, in some use cases, scenarios, and/or implementations, there may be one or more disadvantages, inefficiencies, and/or technical problems in applying a per-antenna CSD insertion for an LTF, which is to be used, for example, for the channel-sounding-based measurements, e.g., as described below.

In one example, a channel-sounding-based measurement based on an LTF may not be accurate, for example, in case the per-antenna CSD insertion is applied to the LTF, e.g., as described below.

For example, in case a transmitter is configured to apply per-antenna CSD insertion on the LTF, the transmitter may cause a single stream transmission to be transmitted via a plurality of Tx chains with different CSD delays, for example, according to the per-antenna CSD insertion.

For example, at a receiver, a perceived delay spread, e.g., caused by the per-antenna CSD insertion at the transmitter, may be increased, for example, with more multipath signals. For example, the multipath signals may stabilize a received signal power. However, this effect may be undesirable for channel-sounding-based measurements.

In one example, a reflecting object may generate multiple multipath estimates with different arrival times. In this case, the per-antenna CSD insertion may be helpful for the channel-sounding-based measurement, for example, only if the receiver knows the corresponding multipath signals of the reflecting object. For example, the channel-sounding-based measurement may not be accurate, for example, if the receiver does not know the corresponding multipath signals of the reflecting object.

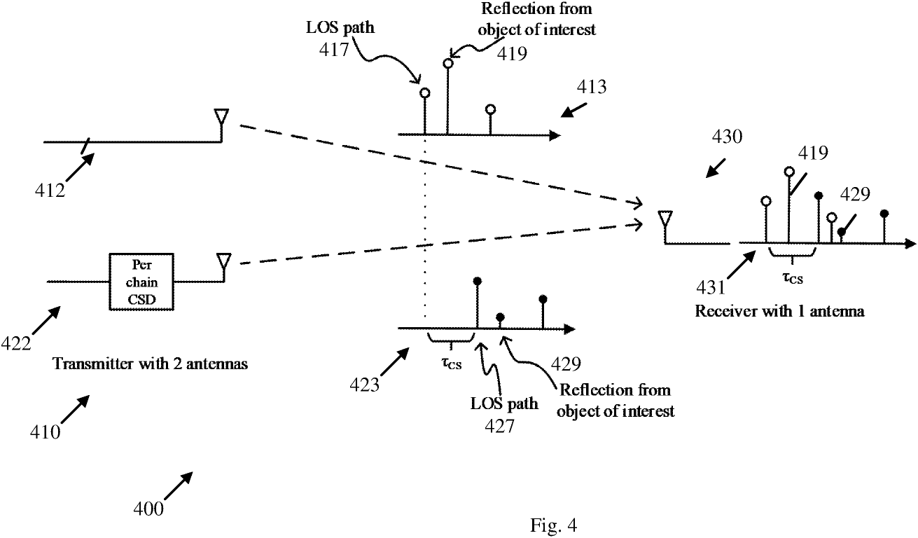

Reference is made to FIG. 4, which schematically illustrates a transmission 400 of a spatial stream between multiple antennas of a transmitter 410 and an antenna of a receiver 430, to demonstrate a technical problem, which may be addressed in accordance with some demonstrative aspects.

In some demonstrative aspects, transmission 400 may be implemented as part of a channel-sounding-based measurement, which may be used, for example, to track an object of interest, which may be in an environment of transmitter 410 and/or receiver 430.

As shown in FIG. 4, transmitter 410 may include two Tx chains associated with two Tx antennas, respectively. For example, transmitter 410 may include a first Tx chain 412 associated with a first Tx antenna, and a second Tx chain 422 associated with a second Tx antenna.

As shown in FIG. 4, transmitter 410 may apply a per-antenna CSD insertion for transmission via the Tx chains 412 and 422.

As shown in FIG. 4, transmitter 410 may apply the per-antenna CSD insertion, for example, by applying a CSD value of 0 over Tx chain 412, and by applying a CSD value of τ_{CS} over Tx chain 422. For example, this per-antenna CSD insertion may result in transmission of a sounding signal via Tx chain 422 being delayed by a delay of τ_{CS}, for example, relative to transmission of the sounding signal via Tx chain 412.

As shown in FIG. 4, receiver 430 may perceive an estimated channel response 431 based on two superimposed channels, e.g., a first channel from the first Tx chain 412 to the receiver 430, and a second channel from the second Tx chain 422 to the receiver 430. For example, the estimated channel response 431 may be based on a first channel response 413 of the first channel from first Tx chain 412 to the receiver 430, and a second channel response 423 of the second channel from second Tx chain 422 to the receiver 430.

As shown in FIG. 4, the first channel response 413 may include a Line of Sight (LoS)-path signal 417, and a reflection signal 419, which may be reflected from the object of interest, for example, based on the sounding signal from Tx chain 412.

As shown in FIG. 4, the second channel response 423 may include a LOS-path signal 427, and a reflection signal 429, which may be reflected from the object of interest, for example, based on the sounding signal from Tx chain 422.

In one example, receiver 430 may be configured to track movement of the object of interest, for example, based on wireless sensing and/or ranging measurements, which may be determined, for example, based on the reflection signal 419 and the reflection signal 429, e.g., which may be reflected from the object of interest.

In some demonstrative aspects, the receiver 430 may not be able to accurately track the movement of the object of interest, for example, if the receiver 430 does not know the CSD values of the per-antenna CSD insertion implemented at the transmitter 410, e.g., as described below.

In one example, in many use cases, a receiver, e.g., receiver 430, may usually not be aware of how many transmit antennas and/or what CSD values have been applied by a transmitter, e.g., transmitter 410, which transmitted the received sounding signal. For example, in many use cases, the transmitter, e.g., transmitter 410, may not be configured to notify the receiver regarding how many transmit antennas and/or what CSD values are being applied. For example, the receiver may only be able to know what is the number of spatial streams, while the receiver may not be able to determine a number of transmit antennas of the spatial stream of a sounding PPDU.

For example, receiver 430 may not be able to identify, based on the estimated channel response 431 which of the received signals are the reflection signal 419 and/or reflection signal 429 for example, if the receiver 430 does not know the CSD values for the per-antenna CSD insertion applied by the transmitter 410.

For example, as shown in FIG. 4, the CSD insertion may result in a partial overlapping between estimates of the first channel 413 and estimates of the second channel 423. Accordingly, receiver 430 may not be able to clearly observe overlapped multipaths of the second channel response 423. For example, receiver 430 may not be able to identify reflection signal 429.

For example, this situation may be worse, in case the overlapping between estimates of the first channel 413 and estimates of the second channel 423 increases, for example, when a number of transmit antennas increases, e.g., when using more than two Tx antennas, e.g., 8 antennas. For example, the CSD value τ_{CS} may be reduced when using a larger number of Tx antennas.

Referring back to FIG. 1, in some demonstrative aspects, device 102, device 140, and/or device 160 may be configured to implement a selective CSD insertion mechanism, which may be configured to provide a technical solution to support channel-sounding-based measurements, for example, for wireless sensing, and/or wireless ranging, e.g., as described below.

In some demonstrative aspects, the selective CSD insertion mechanism may be configured, for example, to provide a technical solution to support channel-sounding-based measurements, e.g., as described below.

In some demonstrative aspects, the selective CSD insertion mechanism may be configured to selectively disable or enable the per-antenna CSD insertion for an LTF, e.g., as described below.

In some demonstrative aspects, the selective CSD insertion mechanism may be configured to define that per-antenna CSD insertion is to be disabled for transmission of a sounding signal, e.g., an LTF, of a PPDU to be configured for a predefined type of channel-sounding-based measurement, e.g., as described below.

In some demonstrative aspects, the selective CSD insertion mechanism may be configured to define that per-antenna CSD insertion is to be disabled for transmission of a sounding signal, e.g., an LTF, of a PPDU to be configured for wireless sensing an/or wireless ranging, e.g., as described below.

In some demonstrative aspects, the selective CSD insertion mechanism may be configured to define that only per-stream CSD insertion is to be allowed for transmission of a sounding signal, e.g., an LTF, of a PPDU to be configured for a predefined type of channel-sounding-based measurement, e.g., as described below.

In some demonstrative aspects, the selective CSD insertion mechanism may be configured to define that only per-stream CSD insertion is to be allowed for transmission of a sounding signal, e.g., an LTF, of a PPDU to be configured for wireless sensing an/or wireless ranging, e.g., as described below.

In some demonstrative aspects, controller 124 may be configured to control, trigger, cause, and/or instruct device 102 to disable a per-antenna CSD insertion for an LTF of a PPDU, for example, based on a determination that the PPDU is to be configured for a predefined type of channel-sounding-based measurement, e.g., as described below.

In some demonstrative aspects, the per-antenna CSD insertion may include insertion of a CSD between the plurality of transmit chains 120, e.g., as described below.

In some demonstrative aspects, controller 124 may be configured to control, trigger, cause, and/or instruct device 102 to transmit the LTF of the PPDU via the plurality of transmit chains 120 with the per-antenna CSD insertion disabled, e.g., as described below.

In some demonstrative aspects, the PPDU may include a PPDU to be transmitted over a channel bandwidth of 320 MHz.

In other aspects, the PPDU nay be transmitted over any other channel bandwidth.

In some demonstrative aspects, the PPDU may include a Null Data Packet (NDP), e.g., as described below.

In some demonstrative aspects, the PPDU may include a wireless sensing PPDU configured for a wireless sensing channel-sounding-based measurement, e.g., as described below.

In some demonstrative aspects, the PPDU may include a wireless ranging PPDU configured for a wireless ranging channel-sounding-based measurement, e.g., as described below.

In some demonstrative aspects, controller 124 may be configured to control, trigger, cause, and/or instruct device 102 to enable the per-antenna CSD insertion for a first LTF of the PPDU, and to disable the per-antenna CSD insertion for a second LTF of the PPDU, e.g., as described below.

In some demonstrative aspects, the first LTF may include an L-LTF, and the second LTF may include a non-legacy LTF after the L-LTF, e.g., as described below.

In some demonstrative aspects, the first LTF may include a non High Throughput (non-HT) LTF, and the second LTF may include a High Efficiency (HE) LTF, e.g., as described below.

In some demonstrative aspects, the first LTF may include a non-HT LTF, and/or the second LTF may include an Extremely High Throughput (EHT) LTF, e.g., as described below.

In other aspects, the first LTF and/or the second LTF may include an LTF of any other LTF type.

In some demonstrative aspects, controller 124 may be configured to control, trigger, cause, and/or instruct device 102 to transmit the first LTF of the PPDU via the plurality of transmit chains 120, for example, with the per-antenna CSD insertion enabled, e.g., as described below.

In some demonstrative aspects, controller 124 may be configured to control, trigger, cause, and/or instruct device 102 to transmit the second LTF of the PPDU via the plurality of transmit chains 120, for example, with the per-antenna CSD insertion disabled, e.g., as described below.

In one example, controller 124 may be configured to enable the per-antenna CSD insertion for L-LTF 204 (FIG. 2) of the PPDU 200 (FIG. 2), and to disable the per-antenna CSD insertion for the non-legacy LTF 216 (FIG. 2) of the PPDU 200 (FIG. 2). For example, controller 124 may be configured to cause transmitter 118 to transmit L-LTF 204 (FIG. 2) with the per-antenna CSD insertion enabled, and to transmit non-legacy LTF 216 (FIG. 2) with the per-antenna CSD insertion disabled.

In some demonstrative aspects, controller 124 may be configured to control, trigger, cause, and/or instruct device 102 to apply the per-antenna CSD insertion to the first LTF, for example, by applying a first Cyclic Shift (CS) to a first transmit chain 120 to transmit the first LTF, and/or by applying a second CS to a second transmit chain 120 to transmit the first LTF, e.g., as described below.

In some demonstrative aspects, the second CS may be different from the first CS, e.g., as described below.

In one example, controller 124 may be configured to cause transmitter 118 to apply a first CS to a first transmit chain 120 to transmit L-LTF 204 (FIG. 2), and/or to apply a second CS, different from the first CS, to a second transmit chain 120 to transmit L-LTF 204 (FIG. 2).

In one example, the first CS may be zero, e.g., no cyclic shift. For example, the cyclic shift value zero may be a special case of cyclic shift. According to this example, applying the per-antenna CSD insertion may include applying a zero CS to the fist transmit chain, and applying a non-zero CS to the second transmit chain.

In some demonstrative aspects, controller 124 may be configured to control, trigger, cause, and/or instruct device 102 to apply a per-stream CSD insertion to a plurality of spatial streams of the LTF, e.g., the second LTF, for which the per-antenna CSD insertion is disabled, e.g., as described below.

In some demonstrative aspects, controller 124 may be configured to control, trigger, cause, and/or instruct device 102 to apply the per-stream CSD insertion according to a P matrix, e.g., as described below.

In some demonstrative aspects, a size of the P matrix may be equal to or greater than a count of the plurality of transmit chains 120, e.g., as described below.

In some demonstrative aspects, controller 124 may be configured to control, trigger, cause, and/or instruct device 102 to apply the per-stream CSD insertion, for example, by applying a first CS to a first spatial stream of the LTF, and applying a second CS to a second spatial stream of the LTF, e.g., as described below.

In some demonstrative aspects, the second CS may be different from the first CS, for example, according to the P matrix, e.g., as described below.

In some demonstrative aspects, controller 124 may be configured to control, trigger, cause, and/or instruct device 102 to apply the per-stream CSD insertion to the plurality of spatial streams of the LTF, for example, prior to mapping the plurality of spatial streams of the LTF to the plurality of transmit chains 120, e.g., as described below.

In some demonstrative aspects, controller 124 may be configured to control, trigger, cause, and/or instruct device 102 to set a spatial mapping matrix to an identity matrix, and to apply the spatial mapping matrix to map one or more space-time streams of the LTF to the plurality of transmit chains 120, e.g., as described below.

In some demonstrative aspects, controller 124 may be configured to control, trigger, cause, and/or instruct device 102 to cause the wireless communication device to enable the per-antenna CSD insertion for an LTF of a data PPDU, e.g., as described below.

In some demonstrative aspects, controller 124 may be configured to control, trigger, cause, and/or instruct device 102 to cause the wireless communication device to transmit the data PPDU via the plurality of transmit chains 120 with the per-antenna CSD insertion enabled, e.g., as described below.

In some demonstrative aspects, the selective CSD insertion mechanism may be configured to disable the per-antenna CSD insertion for the LTF of PPDUs configured for channel-sounding-based measurement, for example, to provide technical solution, which is easy and/or simple to implement.

In some demonstrative aspects, the selective CSD insertion mechanism may be configured to provide a technical solution in which the per-antenna CSD insertion may be disabled for an LTF of a wireless ranging PPDU and/or a wireless sensing PPDU.

In some demonstrative aspects, the selective CSD insertion mechanism may be configured to implement the same per chain CSD values of all transmit antennas, for example, as a way of effectively disabling the per-antenna CSD insertion.

In some demonstrative aspects, the disabling of the per-antenna CSD insertion for the LTF may be performed, for example, setting the spatial mapping matrix Q to an identity matrix. For example, setting the spatial mapping matrix Q to the identify matrix may result in disabling the per-antenna CSD, for example, when the spatial mapping matrix Q is applied to the LTF.

For example, the spatial mapping matrix Q may be defined as a product of the CSD matrix M_{CSD}(k) multiplied by the matrix D, e.g., as described above. Accordingly, setting the spatial mapping matrix Q to the identity matrix may result in removal of phase rotations introduced by the CSD matrix M_{CSD}(k), which may result in disabling the per-antenna CSD.

In some demonstrative aspects, the selective CSD insertion mechanism may be configured to provide a technical solution to use per-stream CSD insertion, for example, instead of the per-antenna CSD insertion, for example, with respect to PPDUs to be used for sensing and/or ranging measurements.

In some demonstrative aspects, the transmitter 118 may assign to a Tx antenna, e.g., to each transmit antenna, for example, a different spatial stream, for example, in order to utilize the per-stream CSD insertion for multiple transmit antennas.

In some demonstrative aspects, the transmitter 118 may be configured to use a sounding signal format for multiple spatial streams, for example, when using the per-stream CSD insertion.

In one example, transmitter 410 (FIG. 4) may use a 2x2 P-matrix encoded NDP sounding, for example, for the per-stream CSD insertion via the two transmit antennas 412 (FIG. 4) and 422 (FIG. 4).

In some demonstrative aspects, the per-stream CSD insertion may be reused, for example, for mitigating an unintentional beamforming effect.

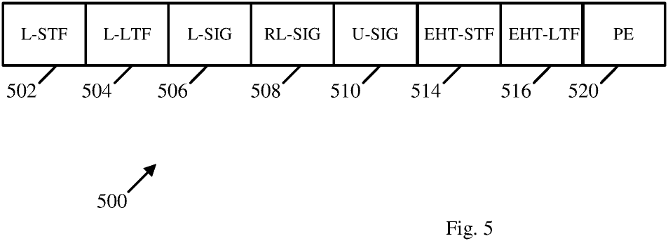

Reference is made to FIG. 5, which schematically illustrates a PPDU format 500, which may be implemented in accordance with some demonstrative aspects. In one example, devices 102 (FIG. 1), 140 (FIG. 1), and/or 160 (FIG. 1) may be configured to generate, transmit, receive, and/or process one or more PPDUs having the structure and/or format of PPDU 500.

In some demonstrative aspects, PPDU 500 may be configured, for example, in compliance with an IEEE 802.11bf Specification.

In some demonstrative aspects, PPDU 500 may be configured, for example, in compliance with a format of an EHT MU PPDU and/or an EHT TB PPDU.

In some demonstrative aspects, devices 102 (FIG. 1), 140 (FIG. 1), and/or 160 (FIG. 1) may be configured to communicate PPDU 500, for example, as part of a channel-sounding-based measurement, e.g., as described below.

In some demonstrative aspects, the channel-sounding-based measurement may include, for example, a wireless sensing channel-sounding-based measurement.

In some demonstrative aspects, PPDU 500 may include, for example, a wireless sensing PPDU, which may be configured for the wireless sensing channel-sounding-based measurement.

In some demonstrative aspects, as shown in FIG. 5, PPDU 500 may include an L-STF 502.

In some demonstrative aspects, as shown in FIG. 5, PPDU 500 may include an LTF, for example, a first LTF, e.g., an L-LTF 504, for example, following the L-STF 502.

In some demonstrative aspects, as shown in FIG. 5, PPDU 500 may include an L-SIG field 506, e.g., after the L-LTF 504.

In some demonstrative aspects, as shown in FIG. 5, PPDU 500 may include an RL-SIG field 508, which may follow the L-SIG field 506. The RL-SIG field 508 may be followed by a U-SIG field 510.

In some demonstrative aspects, as shown in FIG. 5, PPDU 500 may include an EHT-STF 514, e.g., immediately after the U-SIG field 510.

In some demonstrative aspects, as shown in FIG. 5, PPDU 500 may include, for example, a second LTF, e.g., an EHT-LTF 516, for example, following the EHT-STF 514.

In some demonstrative aspects, as shown in FIG. 5, PPDU 500 may include, for example, a PE field 520, e.g., following the EHT-LTF 516.

In some demonstrative aspects, controller 124 (FIG. 1) may be configured to enable a per-antenna CSD insertion for the first LTF of the PPDU 500, e.g., L-LTF 504, and to disable the per-antenna CSD insertion for the second LTF of the PPDU, e.g., EHT-LTF 516, for example, based on a determination that the PPDU 500 is to be configured for a predefined type of channel-sounding-based measurement, e.g., a wireless sensing measurement.

In some demonstrative aspects, controller 124 (FIG. 1) may be configured to transmit the L-LTF 504 of the PPDU 500 via the plurality of transmit chains 120 (FIG. 1) with the per-antenna CSD insertion enabled, and to transmit the EHT-LTF 516 of the PPDU 500 via the plurality of transmit chains 120 (FIG. 1) with the per-antenna CSD insertion disabled, for example, based on a determination that the PPDU 500 is to be configured for a predefined type of channel-sounding-based measurement, e.g., a wireless sensing measurement.

In some demonstrative aspects, disabling the per-antenna CSD insertion for the EHT-LTF 516 of the PPDU 500 may provide a technical solution, for example, to support a wireless sensing channel-sounding-based measurement, for example, with a relatively high level of accuracy.

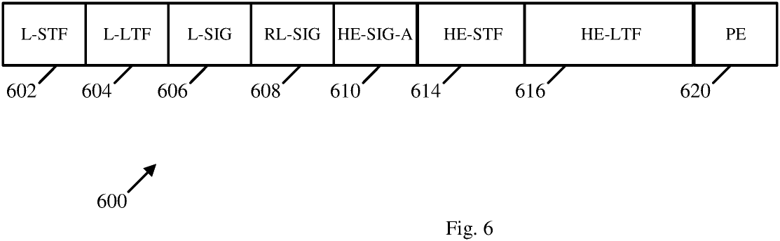

Reference is made to FIG. 6, which schematically illustrates a PPDU format 600, which may be implemented in accordance with some demonstrative aspects. In one example, devices 102 (FIG. 1), 140 (FIG. 1), and/or 160 (FIG. 1) may be configured to generate, transmit, receive, and/or process one or more PPDUs having the structure and/or format of PPDU 600.

In some demonstrative aspects, PPDU 600 may be configured, for example, in compliance with an IEEE 802.11az Specification.

In some demonstrative aspects, devices 102 (FIG. 1), 140 (FIG. 1), and/or 160 (FIG. 1) may be configured to communicate PPDU 600, for example, as part of a channel-sounding-based measurement, e.g., as described below.

In some demonstrative aspects, the channel-sounding-based measurement may include, for example, a wireless ranging channel-sounding-based measurement.

In some demonstrative aspects, PPDU 600 may include, for example, a wireless ranging PPDU, which may be configured for the wireless ranging channel-sounding-based measurement.

In some demonstrative aspects, as shown in FIG. 6, PPDU 600 may include an L-STF 602.

In some demonstrative aspects, as shown in FIG. 6, PPDU 600 may include an LTF, for example, a first LTF, e.g., an L-LTF 604, for example, following the L-STF 602.

In some demonstrative aspects, as shown in FIG. 6, PPDU 600 may include an L-SIG field 606, following the L-LTF 604.

In some demonstrative aspects, as shown in FIG. 6, PPDU 600 may include an RL-SIG field 608, which may follow the L-SIG field 606.

In some demonstrative aspects, as shown in FIG. 6, PPDU 600 may include an HE-SIG-A field 610, e.g., following the RL-SIG field 608.

In some demonstrative aspects, as shown in FIG. 6, PPDU 600 may include an HE-STF field 614, e.g., immediately after the HE-SIG-A field 610.

In some demonstrative aspects, as shown in FIG. 6, PPDU 600 may include, for example, a second LTF, e.g., an HE-LTF 616, for example, following the HE-STF field 614.

In some demonstrative aspects, as shown in FIG. 6, PPDU 600 may include, for example, a PE field 620, e.g., following the HE-LTF 616.

In some demonstrative aspects, controller 124 (FIG. 1) may be configured enable a per-antenna CSD insertion for the first LTF of the PPDU 600, e.g., L-LTF 604, and to disable the per-antenna CSD insertion for the second LTF of the PPDU, e.g., HE-LTF 616, for example, based on a determination that the PPDU 600 is to be configured for a predefined type of channel-sounding-based measurement, e.g., a wireless ranging measurement.

In some demonstrative aspects, controller 124 (FIG. 1) may be configured to transmit the L-LTF 604 of the PPDU 600 via the plurality of transmit chains 120 (FIG. 1) with the per-antenna CSD insertion enabled, and to transmit the HE-LTF 616 of the PPDU 600 via the plurality of transmit chains 120 (FIG. 1) with the per-antenna CSD insertion disabled, for example, based on a determination that the PPDU 600 is to be configured for a predefined type of channel-sounding-based measurement, e.g., a wireless ranging measurement.

In some demonstrative aspects, disabling the per-antenna CSD insertion for the HE-LTF 616 of the PPDU 600 may provide a technical solution, for example, to support a wireless ranging channel-sounding-based measurement, for example, with a relatively high level of accuracy.

Referring back to FIG. 1, in some demonstrative aspects, device 102, device 140, and/or device 160 may be configured to coordinate, negotiate, and/or exchange CSD values to be utilized for the per-antenna CSD insertion, for example, in case per-antenna CSD insertion is to be applied for the LTF of the PPDU to be used for the channel-sounding-based measurement, e.g., as described below.

In some demonstrative aspects, a receiver, e.g., receiver 146, may be configured to be aware of the CSD values of the per-antenna CSD insertion at a plurality of Tx chains of a transmitter. For example, the receiver may use the knowledge of the CSD values to identify corresponding multipaths of the plurality of Tx chains in overlapped channel responses, e.g., the partial overlapping between estimates of the first channel 413 (FIG. 4) and estimates of the second channel 423 (FIG. 4).

In some demonstrative aspects, the CSD values of the per-antenna CSD insertion may be predefined, for example, based on a count of Tx chains, for example, for each number of Tx antennas of the transmitter.

In some demonstrative aspects, the receiver, e.g., receiver 146, may be configured to be able to identify the count of Tx antennas used by the transmitter applying the per-antenna CSD insertion. For example, the receiver may be able to determine the CSD values of the per-antenna CSD insertion, for example, based on the count of Tx chains.

In some demonstrative aspects, one or more predefined CSD values, which may be defined for the per-antenna CSD insertion for a first LTF of a PPDU, e.g., L-LTF 204 (FIG. 2), for example, in a legacy preamble of a PPDU, may be used for the per-antenna CSD insertion for a second LTF of the PPDU, e.g., non-legacy LTF 216 (FIG. 2).

In one example, the following CSD values, which may be defined for the per-antenna CSD insertion for the first LTF, for example, in accordance with an IEEE 802.11ac standard, may be used for the per-antenna CSD insertion for the second LTF of a PPDU configured for wireless sensing and/or ranging, e.g., as follows:

TABLE 1

${T}_{C S}^{{i}_{T X}}$ Values for L-STF, L-LTF, L-Sig and VHT-SIG-A fields of the PPDU

| Total number of Tx chains (N_{TX}) per frequency segment | Cyclic shift for transmit chain i_{TX} (in units of ns) | | | | | | | | |
|---|---|---|---|---|---|---|---|---|---|
| | 1 | 2 | 3 | 4 | 5 | 6 | 7 | 8 | >8 |
| 1 | 0 | - | - | - | - | - | - | - | - |
| 2 | 0 | -200 | - | - | - | - | - | - | - |
| 3 | 0 | -100 | -200 | - | - | - | - | - | - |
| 4 | 0 | -50 | -100 | -150 | - | - | - | - | - |
| 5 | 0 | -175 | -25 | -50 | -75 | - | - | - | - |
| 6 | 0 | -200 | -25 | -150 | -175 | -125 | - | - | - |
| 7 | 0 | -200 | -150 | -25 | -175 | -75 | -50 | - | - |
| 8 | 0 | -175 | -150 | -125 | -25 | -100 | -50 | -200 | - |
| >8 | 0 | -175 | -150 | -125 | -25 | -100 | -50 | -200 | Between -200 and 0 |

In some demonstrative aspects, the receiver and the transmitter may exchange CSD information, for example, including the CSD values, the number of antennas, and/or spatial mapping matrixes Qₖ, e.g., as described below.

In one example, the receiver and the transmitter may exchange the CSD information, for example, during a sounding/ranging negotiation, and/or during a capability exchange.

In one example, the receiver and the transmitter may exchange the CSD information, for example, using one or more frames, for example, an NDP announcement frame, a trigger frame, a sounding/sensing/CSI report frame, a beacon frame, and/or any other additional and/or alternative frame.

In some demonstrative aspects, a transmitter, e.g., transmitter 118, may determine and/or set the CSD values or the antenna number, for example, via an NDP announcement frame, and/or any other additional or alternative frame.

In some demonstrative aspects, a receiver, e.g., receiver 146, may determine and/or set the CSD values or the antenna number, for example, via an uplink sounding trigger frame, and/or any other additional or alternative frame.

In some demonstrative aspects, the receiver may feedback the received sounding signals to the transmitter, for example, via a CSI report frame. In such case, the exchange of CSD values and/or the antenna number between the receiver and the transmitter may not be needed, for example, as the transmitter may know what CSD values it used.

In some demonstrative aspects, device 102, device 140, and/or device 160 may be configured to implement a per-antenna CSD insertion mechanism, which may be defined based on an increased difference between CSD values of a per-antenna CSD insertion, e.g., as described below.

In some demonstrative aspects, as shown in Table 1, a spacing between the CSD values may be as small as 25 ns, which may correspond to about 25 feet in propagation distance difference.

In some demonstrative aspects, two channel responses of two transmit antennas may partially overlap each other, for example, if a delay spread between a transmitter and a receiver is greater than 25 ns. As a result, the receiver may not be able to identify all the corresponding multipath pairs correctly, e.g., as described above with reference to FIG. 4.

In some demonstrative aspects, a minimum value of a CSD value difference for per-antenna CSD insertion may be increased, for example, to allow clearer identification of corresponding multipaths of a same reflecting object.

For example, a minimum value of a CSD value difference in Table 1 may be increased from 25 ns to a larger value, e.g., 100 ns, or any other value.

In one example, as a number of antennas increases, a range of the CSD value increases, for example, such that a frequency selectivity of the channel response perceived at the receiver may increase, and a noise suppression capability offered by channel smoothing may reduce.

In one example, it may be defined that the per-chain CSD insertion may be allowed for a small number of Tx antennas.

In another example, it may be defined that not all Tx antennas may have different per chain CSD values, for example, for a large number of antennas.

For example, controller 124 may cause transmitter 119 to transmit a first LTF of a PPDU, e.g., L-LTF 204 (FIG. 2), via the plurality of transmit chains 120 with a per-antenna CSD insertion according to the CSD values of Table 1. For example, controller 124 may cause transmitter 118 to transmit a second LTF of the PPDU, e.g., non-legacy LTF 216 (FIG. 2), via the plurality of transmit chains 120 with a per-antenna CSD insertion defined with increased minimal CSD values, which may be higher with respect to the minimal CSD values of Table 1. For example, a minimal CSD value of the increased CSD values may be 100 ns, e.g., compared to a minimal CSD value of Table 1, which is 25 ns.

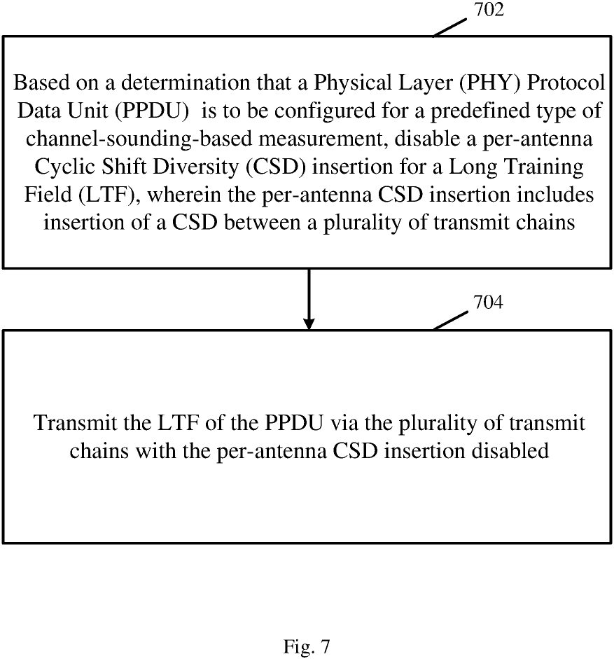

Reference is made to FIG. 7, which schematically illustrates a method of transmitting a PPDU configured for a channel-sounding-based measurement, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include disabling a per-antenna CSD insertion for an LTF of a PPDU, for example, based on a determination that the PPDU is to be configured for a predefined type of channel-sounding-based measurement. For example, the per-antenna CSD insertion may include insertion of a CSD between a plurality of transmit chains. For example, controller 124 (FIG. 1) may be configured to cause, trigger, and/or control device 102 (FIG. 1) to disable the per-antenna CSD insertion for non-legacy LTF 216 (FIG. 2), for example, based on the determination that the PPDU 200 (FIG. 2) is to be configured for a predefined type of channel-sounding-based measurement, e.g., as described above.

As indicated at block 704, the method may include transmitting the LTF of the PPDU via the plurality of transmit chains with the per-antenna CSD insertion disabled. For example, controller 124 (FIG. 1) may be configured to cause, trigger, and/or control device 102 (FIG. 1) to transmit the non-legacy LTF 216 (FIG. 2) via the plurality of transmit chains 120 (FIG. 1) with the per-antenna CSD insertion disabled, e.g., as described above.

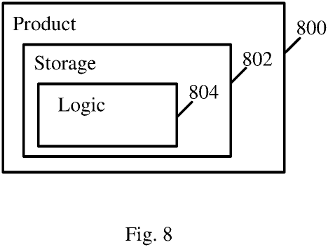

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication device to, based on a determination that a Physical Layer (PHY) Protocol Data Unit (PPDU) is to be configured for a predefined type of channel-sounding-based measurement, disable a per-antenna Cyclic Shift Diversity (CSD) insertion for a Long Training Field (LTF), wherein the per-antenna CSD insertion comprises insertion of a CSD between a plurality of transmit chains; and transmit the LTF of the PPDU via the plurality of transmit chains with the per-antenna CSD insertion disabled.

Example 2 includes the subject matter of Example 1, and optionally, wherein the apparatus is configured to cause the wireless communication device to enable the per-antenna CSD insertion for a first LTF of the PPDU, and to disable the per-antenna CSD insertion for a second LTF of the PPDU.

Example 3 includes the subject matter of Example 2, and optionally, wherein the apparatus is configured to cause the wireless communication device to transmit the first LTF of the PPDU via the plurality of transmit chains with the per-antenna CSD insertion enabled, and to transmit the second LTF of the PPDU via the plurality of transmit chains with the per-antenna CSD insertion disabled.

Example 4 includes the subject matter of Example 2 or 3, and optionally, wherein the first LTF comprises a non High Throughput (non-HT) LTF, and the second LTF comprises an Extremely High Throughput (EHT) LTF.

Example 5 includes the subject matter of Example 2 or 3, and optionally, wherein the first LTF comprises a non High Throughput (non-HT) LTF, and the second LTF comprises a High Efficiency (HE) LTF.

Example 6 includes the subject matter of any one of Examples 2-5, and optionally, wherein the first LTF comprises a Legacy LTF (L-LTF), and the second LTF comprises a non-legacy LTF after the L-LTF.

Example 7 includes the subject matter of any one of Examples 2-6, and optionally, wherein the apparatus is configured to cause the wireless communication device to apply the per-antenna CSD insertion to the first LTF by applying a first Cyclic Shift (CS) to a first transmit chain to transmit the first LTF, and by applying a second CS to a second transmit chain to transmit the first LTF, wherein the second CS is different from the first CS.

Example 8 includes the subject matter of any one of Examples 1-7, and optionally, wherein the apparatus is configured to cause the wireless communication device to apply a per-stream CSD insertion to a plurality of spatial streams of the LTF.

Example 9 includes the subject matter of Example 8, and optionally, wherein the apparatus is configured to cause the wireless communication device to apply the per-stream CSD insertion according to a P matrix, wherein a size of the P matrix is equal to or greater than a count of the plurality of transmit chains.

Example 10 includes the subject matter of Example 8 or 9, and optionally, wherein the apparatus is configured to cause the wireless communication device to apply the per-stream CSD insertion by applying a first Cyclic Shift (CS) to a first spatial stream of the LTF, and applying a second CS to a second spatial stream of the LTF, wherein the second CS is different from the first CS.

Example 11 includes the subject matter of any one of Examples 8-10, and optionally, wherein the apparatus is configured to cause the wireless communication device to apply the per-stream CSD insertion to the plurality of spatial streams of the LTF prior to mapping the plurality of spatial streams of the LTF to the plurality of transmit chains.

Example 12 includes the subject matter of any one of Examples 1-11, and optionally, wherein the apparatus is configured to cause the wireless communication device to set a spatial mapping matrix to an identity matrix, and to apply the spatial mapping matrix to map one or more space-time streams of the LTF to the plurality of transmit chains.

Example 13 includes the subject matter of any one of Examples 1-12, and optionally, wherein the apparatus is configured to cause the wireless communication device to enable the per-antenna CSD insertion for an LTF of a data PPDU, and to transmit the data PPDU via the plurality of transmit chains with the per-antenna CSD insertion enabled.

Example 14 includes the subject matter of any one of Examples 1-13, and optionally, wherein the PPDU comprises a wireless sensing PPDU configured for a wireless sensing channel-sounding-based measurement.

Example 15 includes the subject matter of any one of Examples 1-14, and optionally, wherein the PPDU comprises a wireless ranging PPDU configured for a wireless ranging channel-sounding-based measurement.

Example 16 includes the subject matter of any one of Examples 1-15, and optionally, wherein the PPDU comprises a Null Data Packet (NDP).

Example 17 includes the subject matter of any one of Examples 1-16, and optionally, wherein the PPDU comprises a PPDU for a 320 Megahertz (MHz) channel bandwidth.

Example 18 includes the subject matter of any one of Examples 1-17, and optionally, comprising a radio to transmit the PPDU.

Example 19 includes the subject matter of Example 18, and optionally, comprising one or more antennas connected to the radio, and a processor to execute instructions of an operating system of the wireless communication device.

Example 20 comprises a wireless communication device comprising the apparatus of any of Examples 1-19.

Example 21 comprises an apparatus comprising means for executing any of the described operations of any of Examples 1-19.

Example 22 comprises a product comprising one or more tangible computer-readable non-transitory storage media comprising instructions operable to, when executed by at least one processor, enable the at least one processor to cause a wireless communication device to perform any of the described operations of any of Examples 1-19.

Example 23 comprises an apparatus comprising: a memory interface; and processing circuitry configured to: perform any of the described operations of any of Examples 1-19.

Example 24 comprises a method comprising any of the described operations of any of Examples 1-19.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication device to:
based on a determination that a Physical Layer (PHY) Protocol Data Unit (PPDU) is to be configured for a predefined type of channel-sounding-based measurement, disable a per-antenna Cyclic Shift Diversity (CSD) insertion for a Long Training Field (LTF), wherein the per-antenna CSD insertion comprises insertion of a CSD between a plurality of transmit chains; and
transmit the LTF of the PPDU via the plurality of transmit chains with the per-antenna CSD insertion disabled.

2. The apparatus of claim 1 configured to cause the wireless communication device to enable the per-antenna CSD insertion for a first LTF of the PPDU, and to disable the per-antenna CSD insertion for a second LTF of the PPDU.

3. The apparatus of claim 2 configured to cause the wireless communication device to transmit the first LTF of the PPDU via the plurality of transmit chains with the per-antenna CSD insertion enabled, and to transmit the second LTF of the PPDU via the plurality of transmit chains with the per-antenna CSD insertion disabled.

4. The apparatus of claim 2, wherein the first LTF comprises a non High Throughput (non-HT) LTF, and the second LTF comprises an Extremely High Throughput (EHT) LTF.

5. The apparatus of claim 2, wherein the first LTF comprises a non High Throughput (non-HT) LTF, and the second LTF comprises a High Efficiency (HE) LTF.

6. The apparatus of claim 2, wherein the first LTF comprises a Legacy LTF (L-LTF), and the second LTF comprises a non-legacy LTF after the L-LTF.

7. The apparatus of claim 2 configured to cause the wireless communication device to apply the per-antenna CSD insertion to the first LTF by applying a first Cyclic Shift (CS) to a first transmit chain to transmit the first LTF, and by applying a second CS to a second transmit chain to transmit the first LTF, wherein the second CS is different from the first CS.

8. The apparatus of claim 1 configured to cause the wireless communication device to apply a per-stream CSD insertion to a plurality of spatial streams of the LTF.

9. The apparatus of claim 8 configured to cause the wireless communication device to apply the per-stream CSD insertion according to a P matrix, wherein a size of the P matrix is equal to or greater than a count of the plurality of transmit chains.

10. The apparatus of claim 8 configured to cause the wireless communication device to apply the per-stream CSD insertion by applying a first Cyclic Shift (CS) to a first spatial stream of the LTF, and applying a second CS to a second spatial stream of the LTF, wherein the second CS is different from the first CS.

11. The apparatus of claim 8 configured to cause the wireless communication device to apply the per-stream CSD insertion to the plurality of spatial streams of the LTF prior to mapping the plurality of spatial streams of the LTF to the plurality of transmit chains.

12. The apparatus of claim 1 configured to cause the wireless communication device to set a spatial mapping matrix to an identity matrix, and to apply the spatial mapping matrix to map one or more space-time streams of the LTF to the plurality of transmit chains.

13. The apparatus of claim 12 configured to cause the wireless communication device to enable the per-antenna CSD insertion for an LTF of a data PPDU, and to transmit the data PPDU via the plurality of transmit chains with the per-antenna CSD insertion enabled.

14. The apparatus of claim 1, wherein the PPDU comprises a wireless sensing PPDU configured for a wireless sensing channel-sounding-based measurement.

15. The apparatus of claim 1, wherein the PPDU comprises a wireless ranging PPDU configured for a wireless ranging channel-sounding-based measurement.

16. The apparatus of claim 1, wherein the PPDU comprises a Null Data Packet (NDP).

17. The apparatus of claim 1, wherein the PPDU comprises a PPDU for a 320 Megahertz (MHz) channel bandwidth.

18. The apparatus of claim 1 comprising a radio to transmit the PPDU.

19. The apparatus of claim 18 comprising one or more antennas connected to the radio, and a processor to execute instructions of an operating system of the wireless communication device.

20. A product comprising one or more tangible computer-readable non-transitory storage media comprising instructions operable to, when executed by at least one processor, enable the at least one processor to cause a wireless communication device to:
based on a determination that a Physical Layer (PHY) Protocol Data Unit (PPDU) is to be configured for a predefined type of channel-sounding-based measurement, disable a per-antenna Cyclic Shift Diversity (CSD) insertion for a Long Training Field (LTF), wherein the per-antenna CSD insertion comprises insertion of a CSD between a plurality of transmit chains; and
transmit the LTF of the PPDU via the plurality of transmit chains with the per-antenna CSD insertion disabled.

21. The product of claim 20, wherein the instructions, when executed, cause the wireless communication device to enable the per-antenna CSD insertion for a first LTF of the PPDU, and to disable the per-antenna CSD insertion for a second LTF of the PPDU.

22. The product of claim 21, wherein the instructions, when executed, cause the wireless communication device to transmit the first LTF of the PPDU via the plurality of transmit chains with the per-antenna CSD insertion enabled, and to transmit the second LTF of the PPDU via the plurality of transmit chains with the per-antenna CSD insertion disabled.

23. The product of claim 20, wherein the instructions, when executed, cause the wireless communication device to set a spatial mapping matrix to an identity matrix, and to apply the spatial mapping matrix to map one or more space-time streams of the LTF to the plurality of transmit chains.

24. An apparatus for a wireless communication device, the apparatus comprising:
means for, based on a determination that a Physical Layer (PHY) Protocol Data Unit (PPDU) is to be configured for a predefined type of channel-sounding-based measurement, disabling a per-antenna Cyclic Shift Diversity (CSD) insertion for a Long Training Field (LTF), wherein the per-antenna CSD insertion comprises insertion of a CSD between a plurality of transmit chains; and
means for causing the wireless communication device to transmit the LTF of the PPDU via the plurality of transmit chains with the per-antenna CSD insertion disabled.

25. The apparatus of claim 24 comprising means for enabling the per-antenna CSD insertion for a first LTF of the PPDU, and to disable the per-antenna CSD insertion for a second LTF of the PPDU.
